(19) United States
(12) Patent Application Publication
(10) Pub. No.: US 2014/0033104 A1
(43) Pub. Date: Jan. 30, 2014

(54) GROUPING BUSINESS OBJECTS

(71) Applicants: Vincent LAVOIE, Montreal (CA); Edward PALMER, Westmount (CA); Xuebo LIANG, Brossard (CA); Roy GHORAYEB, Montreal (CA); Rolan ABDUKALYKOV, Montreal (CA); Mohannad EL-JAYOUSI, L'Ile-Bizard (CA); Alain GAUTHIER, Montreal (CA)

(72) Inventors: Vincent LAVOIE, Montreal (CA); Edward PALMER, Westmount (CA); Xuebo LIANG, Brossard (CA); Roy GHORAYEB, Montreal (CA); Rolan ABDUKALYKOV, Montreal (CA); Mohannad EL-JAYOUSI, L'Ile-Bizard (CA); Alain GAUTHIER, Montreal (CA)

(73) Assignee: SAP AG, Walldorf (DE)

(21) Appl. No.: 13/561,958

(22) Filed: Jul. 30, 2012

(51) Int. Cl. G06F 3/048

(52) U.S. Cl. 715/771

(57) ABSTRACT

Scale(s) on one or more axes may be displayed on a graphical user interface. The scale(s) may present a range of values associated with business object attribute(s). Visual representation(s) associated with business object(s) may be displayed on the graphical user interface. The visual representation(s) may be positioned relative to the scale(s). In response to activation of a grouping mechanism, the visual representation(s) may be moved to a first area in the graphical user interface. The business object(s) associated with the visual representation(s) may include business object attribute value(s) in common with other business objects visually represented in the first area.

### BACKGROUND

Business software such as enterprise resource planning (ERP) software implements business processes by modeling business data as business objects (BOs) with data exchange between the BOs. The business data provided via BOs can be accessed through mechanisms such as graphical user interfaces (GUIs), forms, and analytical reports.

Traditionally, GUIs providing access to BOs conveyed limited information about the attributes associated with the BOs. In addition, the information presented by the GUIs could not be efficiently grouped visually based on the needs of a user.

### BRIEF DESCRIPTION OF THE DRAWINGS

FIG. 1 illustrates a GUI to display BOs according to an embodiment.

FIG. 2 illustrates a GUI to display BOs according to an embodiment.

FIG. 3 illustrates a GUI to display BOs according to an embodiment.

FIG. 4 illustrates an exemplary interface to customize visual properties of areas displaying groups of BO visual representations.

FIG. 5 shows an exemplary architecture in an embodiment of the invention.

### DETAILED DESCRIPTION

Embodiments may be discussed in systems to efficiently group BOs. In an embodiment, scale(s) on one or more axes may be displayed on a graphical user interface. The scale(s) may present a range of values associated with business object attribute(s). Visual representation(s) associated with business object(s) may be displayed on the graphical user interface. The visual representation(s) may be positioned relative to the scale(s). In response to activation of a grouping mechanism, the visual representation(s) may be moved to a first area in the graphical user interface. The business object(s) associated with the visual representation(s) may include business object attribute value(s) in common with other business objects visually represented in the first area.

In an embodiment, the activation of the grouping mechanism may include specifying business object attribute value(s) as a parameter of the grouping mechanism. In an embodiment, the specified business object attribute value(s) may be saved as a parameter available for subsequent grouping mechanism activations. In an embodiment, one or more visual properties of the first area may be varied based on information associated with business objects visually represented in the first area. In an embodiment, the one or more visual properties may be a color, a pattern, a video, text, and/or an image in the first area. In an embodiment, a visual key to indicate meaning(s) of the one or more visual properties may be displayed.

Business software usually includes a standard set of BOs which can be utilized by the software user to model a business entity. For example, in an embodiment, business software may include BOs representing business entities such as business promotions (trade promotions), sales orders, sales quotes, customer quotes, service documents, business opportunities, etc. Each BO may include attributes which define metadata associated with the BO. For example, a business promotion BO may represent a business promotion offered by a first company through a second company to consumers. The first company may be a soft drink company and the second company may be a major retailer. The promotion may have a start date and an end date (a promotion period). The promotion may offer the product, for example, a soft drink, for the promotion period at a particular sale price. The business promotion BO may include attributes such as the name of the second company, the size of the second company, the type of the second company, the name of the promotion product, the sale price of the product during the promotion, the price of the product without the promotion, the quantity of the product sold during the promotion, the start date of the promotion, and the end date of the promotion.

Attributes of BOs may indicate a range of values. For example, in an embodiment, a business promotion BO may include one or more attributes indicating the time period for which the business promotion is valid. The time period may be implemented by either defining a single time period attribute associated with the business promotion BO or by defining a start date attribute and an end date attribute associated with the business promotion BO. Similarly, in another example embodiment, the business promotion may only apply if particular quantities of a product are purchased. Therefore, the business promotion BO may include one or more attributes indicating a range of quantities to which the business promotion applies to.

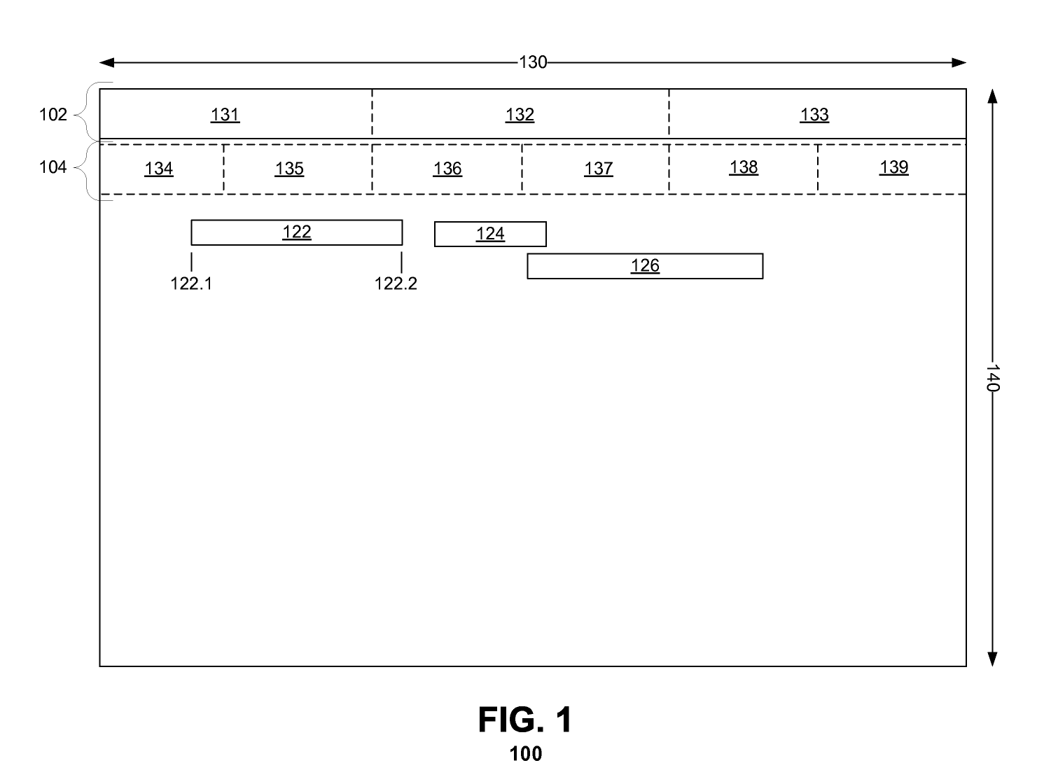

FIG. 1 illustrates a GUI 100 to display BOs according to an embodiment. In an embodiment, BOs may be displayed on a GUI 100 in an organized manner to visually convey information about the BOs. The GUI 100 may display one or more scales 102, 104 on the x-axis 130 and/or y-axis 140. The GUI 100 may display visual representations of BOs such as 122, 124, and 126 mapped in relationship to the attributes on the x-axis 130 and/or y-axis 140.

In an embodiment, the attribute(s) displayed across the x-axis 130 and/or y-axis 140 may be presented as one or more scales displaying attribute values (for example, 102 and 104). In an embodiment, if multiple scales are presented on a particular axis, each scale may be graduated based on different granularities. For example, scales 102 and 104 may represent time periods. Scale 102 may be graduated into year units. Specifically, each of 131, 132, and 133 may represent a year. Scale 104 may be graduated on a semi-annual basis. Specifically, 134-139 may each represent half of a year.

In an embodiment, there may be a correlation between the multiple scales on a particular axis. For example, there may be a correlation between the units of scale 102 and scale 104. Time period 131 on scale 102 may represent a particular year, such as year 2012. The time period 134 may represent the first half of the year 2012, and the time period 135 may represent the second half of year 2012. In an embodiment the correlated portions of multiple scales may be presented directly above/below (x-axis) or directly beside (y-axis) each other. For example, time period 131 may be located directly above/below corresponding time periods 134 and 135.

The scale(s) displayed on the x-axis and/or y-axis 102 and 104 may be a range of contiguous values and/or discrete values. For example, the scales 102 and 104 may represent a contiguous time period of three years, a contiguous price range between zero Canadian dollars and 30 Canadian dollars, a contiguous temperature range between 0 degrees Fahrenheit and 90 degrees Fahrenheit, etc. In another example, the scales 102 may represent discrete products such as car A (131), car B (132) and car C (133).

In an embodiment, one or more scales (not shown) may be presented on the y-axis 140. The y-axis scale(s) may be presented and function similar to the x-axis scale(s) described above. Although only two axes (x and y) are illustrated in FIG. 1, a person having ordinary skill in the art will appreciate that GUI 100 may be extended to display additional axes. For example, a z-axis (with corresponding scale(s)) may be displayed by utilizing shading to show the third dimension. In a further example, the z-axis (with corresponding scale(s)) may be presented by displaying GUI 100 on a display which is 3-dimension (3D) compatible.

In an embodiment, the BO(s) displayed on the GUI 100 may be positioned and presented based on respective attribute value(s) of the BO(s) relative to the x-axis and/or y-axis scale(s) of GUI 100. In an example embodiment, scale 102 may be displayed on the GUI 100 and may indicate a time period range as explained above. BOs 122, 124, and 126 may be visual representations of business promotion BOs. Each BO represented by 122, 124, and 126 may include attributes indicating the business promotion period of the respective business promotion BO. The BO visual representations 122, 124, and 126 may be presented to visually convey the span of the business promotion periods, and the start/end of the business promotion periods. For example, time periods 131, 132, and 133 may represent years 2012, 2013, and 2014 respectively. Business promotion BO 122 may have a business promotion period from Apr. 14, 2012 to Jan. 23, 2013. Thus, BO 122 may be presented as a horizontal bar extending from start point 122.1 positioned below time period 131 to end point 122.2 positioned below time period 132. The start point 122.1 may line up with a point in the time period 131 which approximately corresponds to Apr. 14, 2012, and the end point 122.2 may line up with a point in the time period 132 which approximately corresponds to Jan. 23, 2013.

In an example embodiment, multiple scales 102 and 104 may be presented on the GUI 100 and the BO visual representations 122, 124, and 126 may be presented relative to the multiple scales. For example, time periods 134, 135, and 136 may represent the first half of year 2012, the second half of year 2012, and the first half of year 2013 respectively. Business promotion BO 122 may have a business promotion period from Apr. 14, 2012 to Jan. 23, 2013 as described previously. Thus, BO 122 may be presented as a horizontal bar extending from start point 122.1 positioned below time periods 131 and 134 to end point 122.2 positioned below time periods 132 and 136. The start point 122.1 may line up with points in the time periods 131 and 134 which approximately correspond to Apr. 14, 2012, and the end point 122.2 may line up with points in the time periods 132 and 136 which approximately correspond to Jan. 23, 2013.

In an embodiment, the GUI 100 may include multiple axes and one or more scales on each of the multiple axes. Each axis (and the associated scale(s)) may represent different BO attributes. Thus, the BO(s) presented on the GUI 100 may be presented relative to the scale(s) on each axis. For example, the scale(s) on an x-axis may represent time periods and the scale(s) on a y-axis may represent price ranges. Consequently, the bars 122, 124, and 126 representing BOs such as business promotion BOs may be displayed based on the BOs' respective business promotion periods and business promotion prices. The length of the bars 122, 124, and 126 may correspond to the business promotion period, and the width of the bars 122, 124, and 126 may correspond to the business promotion price. Similarly, BOs may be displayed relative to three axes by displaying the BOs as 3D bars and varying the length, width, and depth of the bars to correspond to the scale(s) on the three axes.

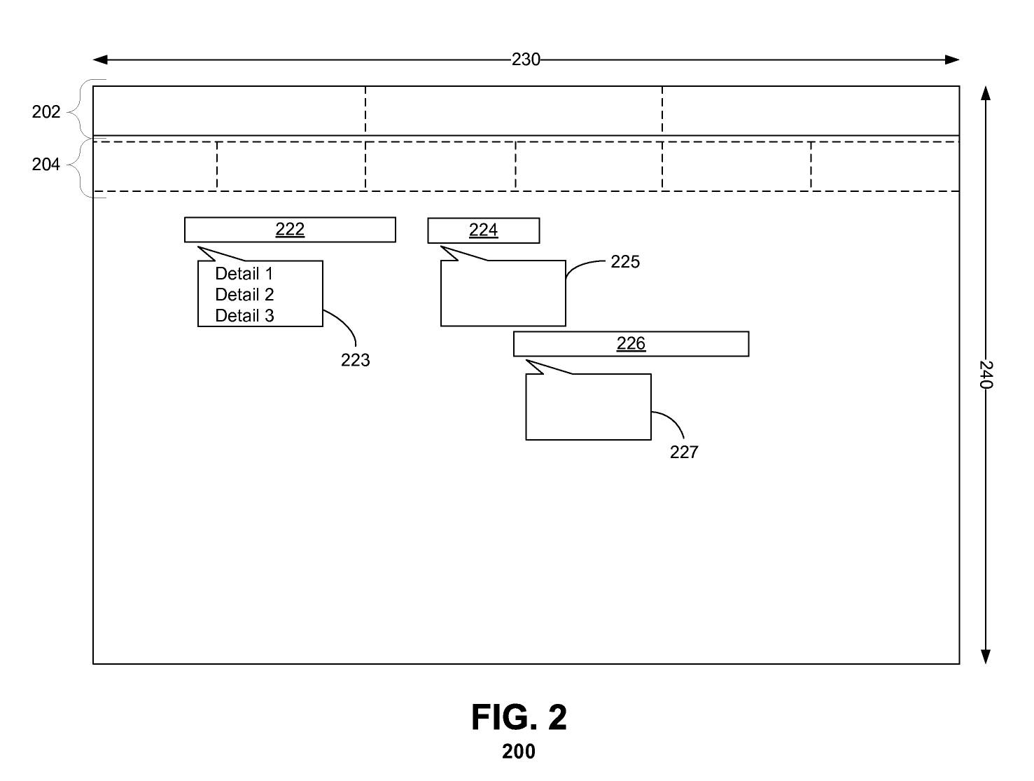

FIG. 2 illustrates a GUI 200 to display BOs according to an embodiment. In an embodiment, BOs may be displayed on a GUI 200 in an organized manner to visually convey information about the BOs. The GUI 200 may display one or more scales 202 and 204 on the x-axis 230 and/or y-axis 240. The GUI 200 may display visual representations of BOs such as 222, 224, and 226 mapped in relationship to the attributes on the x-axis 230 and/or y-axis 240 as discussed in the description pertaining to FIG. 1 above. The GUI 200 may display detail boxes 223, 225, and 227 which present details about BOs associated with BO visual representations 222, 224, and 226 respectively.

In an embodiment, the detail boxes 223, 225, and 227 may display attributes and/or other metadata associated with the respective BOs. The information presented in the detail boxes 223, 225, and 227 may be customized through GUI 200 and/or another GUI so that only the required details are displayed. In an embodiment, the size of the detail boxes 223, 225, and 227 may be customized through GUI 200 and/or another GUI to tweak the readability of the information presented in the detail boxes. In an embodiment, the user may be able to dynamically change the size of a detail box by, for example, selecting the border(s) of the detail box and dragging the border(s) of the detail box to a desired position. The user may select and drag the border(s) of the detail box by, for example, his/her finger (when utilizing a touch screen), a mouse, keyboard, trackball, etc. In an embodiment, all detail boxes 223, 225, and 227 may be displayed without the need for a user to perform any actions on BO visual representations 222, 224, and 226. Specifically, the detail boxes may be displayed without the need for the user to click on or hover a cursor over the BO visual representations 222, 224, and 226.

In a further embodiment, a toggle switch (not shown) may be presented on the GUI 200 to turn on/off the display of detail boxes. Activating the toggle switch when the detail boxes are displayed may remove all detail boxes 223, 225, and 227 from the GUI 200. In addition, the BO visual representations 222, 224, and 226 may be repositioned on the GUI 200 to better utilize the space realized from not displaying the detail boxes 223, 225, and 227. Activating the toggle switch when the detail boxes 223, 225, and 227 are not displayed may re-display the detail boxes 223, 225, and 227 again. A person having ordinary skill in the art will appreciate that the toggle switch may be implemented in many ways including a button, radio buttons, check boxes, drop down menus, etc. In an embodiment, the toggle switch may not be presented on the GUI 200, but may be implemented through output from a motion sensor within the device displaying the GUI 200. For example, shaking and/or tilting a PC tablet in a particular manner may toggle the display of detail boxes.

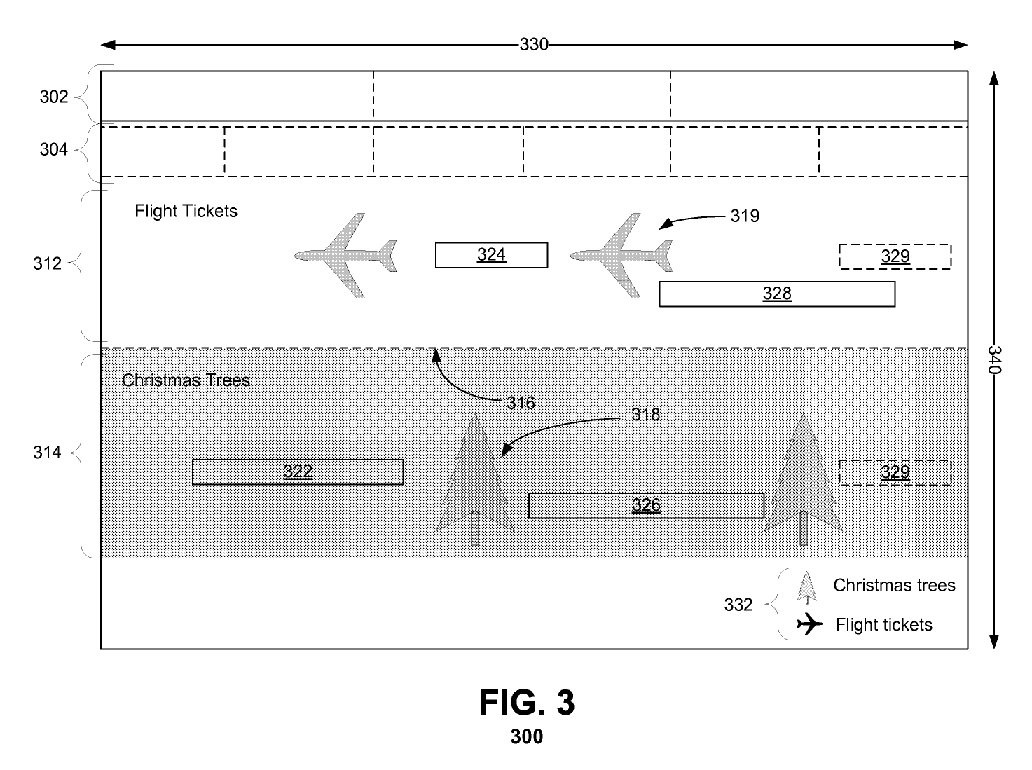

FIG. 3 illustrates a GUI 300 to display BOs according to an embodiment. In an embodiment, BOs may be displayed on GUI 300 in an organized manner to visually convey information about the BOs. The GUI 300 may display one or more scales 302 and 304 on the x-axis 330 and/or y-axis 340. The GUI 300 may display visual representations of BOs such as 322, 324, 326, and 328 mapped in relationship to the attributes on the x-axis 330 and/or y-axis 340 as discussed in the description pertaining to FIG. 1 above. The GUI 300 may display detail boxes (not shown) which present details about BOs associated with BO visual representations 322, 324, 326, and 328 as discussed in the description pertaining to FIG. 2 above. The GUI 300 may include areas 312 and 314 to separately present groups of visual representations when a grouping mechanism is activated.

In an embodiment, the visual representations of BOs displayed on GUI 300 may be grouped based on common attributes and/or metadata of the respective underlying BOs and the groups may be separately presented in different areas of GUI 300. For example, the BOs underlying visual representations 322, 324, 326, and 328 may be business promotion BOs. The underlying business promotion BOs of visual representations 322, 324, 326, and 328 may include attributes/metadata indicating the products associated with the respective business promotions. The business promotions associated with visual representations 324 and 328 may be for flight tickets. The business promotions associated with visual representations 322 and 326 may be for Christmas trees. A grouping function may be activated to group visual representations 322, 324, 326, and 328 based on the products associated with the respective underlying business promotion BOs. As a result, the visual representations 324 and 328 may be visually grouped in a first area 312 in GUI 300 and the visual representations 322 and 326 may be visually grouped in a second area 314 in GUI 300. Specifically, the first area 312 may present a first group of visual representations (324 and 328) with underlying BOs associated with flight tickets and the second area 314 may present a second group of visual representations (322 and 326) with underlying BOs associated with Christmas trees. Therefore, a user viewing the GUI 300 may easily distinguish between business promotions offering different products.

In an embodiment, a visual representation may be grouped into more than one group. For example, a single business promotion may apply to multiple products. The business promotion associated with visual representation 329 may be for both Christmas trees and flight tickets (for example, reduced prices on Christmas trees may be offered for purchasing discounted flight tickets during the Christmas season). Therefore, when a grouping function is activated to group business promotion visual representations based on products, the visual representation 329 may be displayed in both the first area 312 and the second area 314.

In an embodiment, each area 312 and 314 may display the detail boxes (as described in the discussion pertaining to FIG. 2) corresponding to the visual representations displayed in each area 312 and 314.

A person having ordinary skill in the art will appreciate that activation of the grouping mechanism may be implemented in many ways including one or more buttons, radio buttons, check boxes, drop down menus, sensors on a touch screen of a device displaying GUI 300, etc. In an embodiment, activation of displayed elements may be implemented through output from a motion sensor within the device displaying the GUI 300. For example, shaking and/or tilting a PC tablet in a particular manner may activate the grouping mechanism. In an embodiment, the GUI 300 may include text areas to specify the grouping parameters (i.e., the attributes/metadata to be used for the grouping). In a further embodiment, available grouping parameters may be pre-populated in, for example, a drop-down menu, so that a user may choose one or more of the pre-populated parameters for the grouping. In a further embodiment, grouping parameters used for one or more groupings may be saved for future groupings. For example, as explained above, business promotion BOs may be grouped based on products by specifying “product” as a grouping parameter. The grouping parameter may then be saved so that the user can perform the same grouping in the future without having to manually specify the parameter again.

In an embodiment, to visually convey the separation between different groups of BO visual representations, the visual properties of areas 312 and 314 may be distinct. Areas 312 and 314 may have different background colors, background patterns, background texts, headings, background images, background videos, etc. For example, the area 312 may have a white background while the area 314 may have a grey background. In an embodiment, the areas 312 and 314 may be visually separated by a boundary 316.

In an embodiment, the visual properties of areas 312 and 314 may reflect the metadata/attributes of the BOs displayed within each area. In an embodiment, the visual properties of areas 312 and 314 may reflect the metadata/attributes of the underlying BOs used for grouping the visual representations of the BOs. For example, as explained above, a grouping function may be activated to group visual representations 322, 324, 326, and 328 based on the products associated with the respective underlying business promotion BOs. As a result, the visual representations 324 and 328 may be visually grouped in a first area 312 in GUI 300 and the visual representations 322 and 326 may be visually grouped in a second area 314 in GUI 300. Specifically, the first area 312 may present a first group of visual representations (324 and 328) with underlying BOs associated with flight tickets and the second area 314 may present a second group of visual representations (322 and 326) with underlying BOs associated with Christmas trees. In an example embodiment, the first area 312 may display background images of airplanes 319 to indicate that area 312 is displaying visual representations of business promotions grouped by product and that the product for the business promotions in area 312 is flight tickets. Similarly, the second area 314 may display background images of Christmas trees 318 to indicate that area 314 is displaying visual representations of business promotions grouped by product and that the product for the business promotions in area 312 is Christmas trees. Likewise, in other embodiments, areas 312 and 314 may have different background colors, background patterns, background texts, headings, background images, and/or background videos which reflect the metadata/attributes of the BOs displayed within each area.

In an embodiment, a visual key to describe the meanings of various visual properties of the areas 312 and 314 may be displayed on GUI 300 and/or another GUI such as a pop-up window triggered by a user action. For example, the visual key 332 may include information which explains the different meanings associated with certain icons, images, colors, videos, etc., discussed above. The visual key 332 may indicate that an area with airplane images presents BOs pertaining to airline tickets and that an area with Christmas tree images presents BOs pertaining to Christmas trees.

In an embodiment, a toggle switch (not shown) may be presented on the GUI 300 and/or another GUI to turn on/off the display of the visual key 332. A person having ordinary skill in the art will appreciate that the toggle switch may be implemented in many ways including a button, radio buttons, check boxes, drop down menus, etc. In an embodiment, the toggle switch may not be presented on a GUI, but may be implemented through output from a motion sensor within the device displaying the GUI. For example, shaking and/or tilting a PC tablet in a particular manner may toggle the display of the visual key 332.

Although FIG. 3 has been illustrated with two areas to display two groupings of BO visual representations, a person having ordinary skill in the art will appreciate that in other embodiments, any number of groups may be displayed on the GUI 300 based on the attributes/metadata of the underlying BOs.

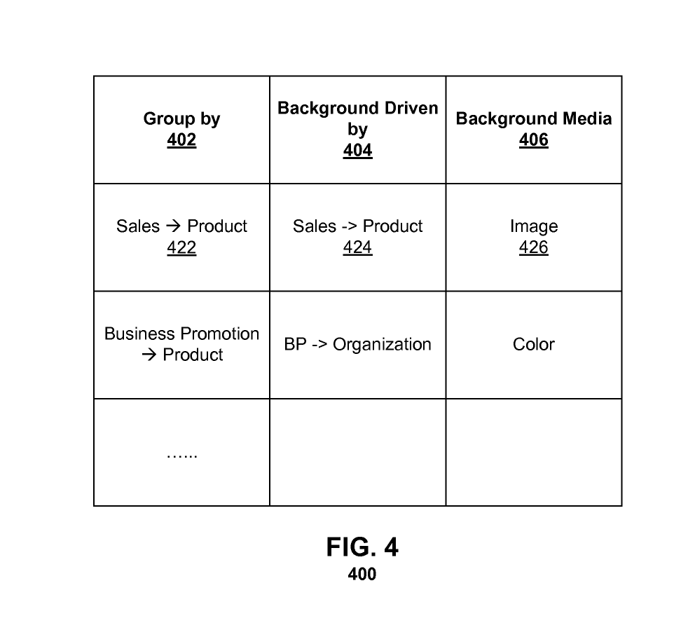

FIG. 4 illustrates an exemplary interface 400 to customize visual properties of areas displaying groups of BO visual representations as described in the discussion pertaining to FIG. 3 above. In an embodiment, the BO attributes/metadata which affect the visual properties of areas such as 312 and 314 may be customized through the interface 400. The interface 400 may include a “Group by” column 402 to list the different available grouping parameters. For each grouping parameter set in the Group by column 402, a user may define BO attributes/metadata 404 and 406 which drive the background of areas displaying BO groups as described in the discussion pertaining to FIG. 3. For example, the user may define the backgrounds of areas displaying sales BOs grouped by the product parameter 422 to be driven by the “product” attribute/metadata 424 of the sales BOs. The product attribute of each sales BO may be set to, for example, one of two possible values: flight tickets or Christmas trees. In an embodiment, based on the value of the product attribute, the user may define whether an image, color, video, etc., should be varied in the areas displaying the groups of BOs (specified in column 406). For example, the user may define that one or more images displayed in the areas displaying the groups of BOs should vary based on the product attribute value (424). In an embodiment, the user may further define that an image displaying airplanes should be displayed in a grouping area if the sales BOs displayed in that area have a product attribute value of flight tickets. Similarly, the user may define that videos, colors, patterns, etc., should be varied within the grouping areas based on attributes/metadata associated with the BOs displayed in the respective grouping areas.

In an embodiment, the user may define through interface 400 or another interface (not shown), the image/color/pattern/video which should be associated with particular values of BO attributes/metadata. For example, as explained above, the user may define through interface 400 that the backgrounds of grouping areas should vary based on the underlying sales BO's product attribute. The product attribute of each sales BO may be set to one of two possible values: flight tickets or Christmas trees. The user may further define the particular colors, patterns, images, videos, etc., which should be associated with the flight tickets product and the Christmas trees product. The user may define that the flight tickets product is associated with a background text displaying the words “flight tickets,” a white background color, etc. In a further embodiment, the user may associate BO attribute values/metadata with absolute and/or relative paths indicating images, videos, colors, and/or patterns.

Although the interface 400 is shown in a table format for illustration purposes, a person having ordinary skill in the art will appreciate that the appearance of the interface can vary as long as the interface provides mechanisms to map BO attributes/metadata to visual properties of grouping areas. In an embodiment, the interface 400 may be any GUI serving as a front-end to one or more databases or other type of storage with BO information/mappings. The interface 400 may include buttons, radio buttons, check boxes, drop down menus, text areas where text may be entered by a user, etc.

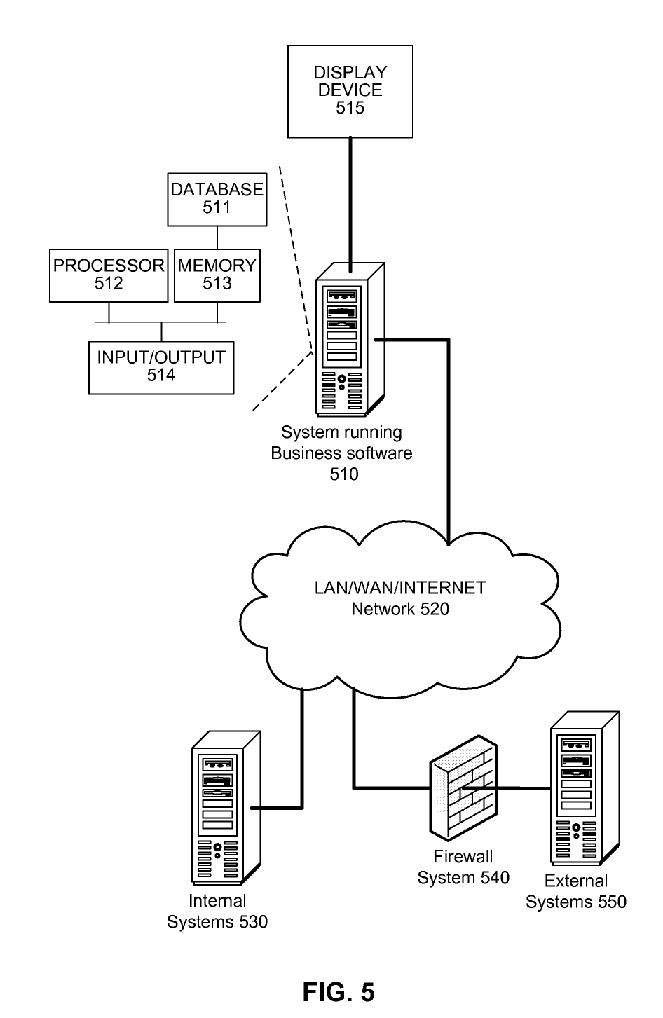

FIG. 5 shows an exemplary architecture in an embodiment of the invention. The system running an application to view, create, or modify BOs 510 may be coupled to a display device 515, existing internal systems 530 through a network 520 and to external systems 550 through the network 520 and firewall system 540. The system running an application to view, create, or modify BOs 510 may include a desktop computer, laptop computer, tablet PC, client computer, mobile phone, central computer in a vehicle, any device with a touch screen, and any other computer. The display device 515 may include a computer monitor, a touch screen, a tablet PC screen, a mobile phone screen, and any other displays. The existing internal systems 530 may include a server and may provide business data and/or other data. The external systems 550 may include a server and may be maintained by a third party, such as an information service provider, and may contain business data and/or other data, that may be updated by the third party on a periodic basis. The system running an application to view, create, or modify BOs 510 may interact with these external systems to obtain updates through a firewall system 540 separating the internal systems from the external systems.

A person having ordinary skill in the art will appreciate that while internal systems 530 and external systems 550 are included in FIG. 5, in some embodiments, one or both of these systems may not be required. In an embodiment, the functionality provided by the internal systems 530 and external systems 550 may be provided by the system running the application to view, create, or modify BOs 510.

Each of the systems in FIG. 5 may contain a processing device 512, memory 513, a database 511, and an input/output interface 514, all of which may be interconnected via a system bus. In various embodiments, each of the systems 510, 530, 540, and 550 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 513 may contain different components for retrieving, presenting, changing, and saving data. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system.

Database 511 may include any type of data storage adapted to searching and retrieval. The database 511 may include SAP database (SAP DB), Informix, Oracle, DB2, Sybase, and other such database systems. The database 511 may include SAP's HANA (high performance analytic appliance) in-memory computing engine and other such in-memory databases.

Processing device 512 may perform computation and control functions of a system and comprises a suitable central processing unit (CPU). Processing device 512 may comprise a single integrated circuit, such as a microprocessing device, or may comprise any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method comprising:
displaying, on a graphical user interface, at least one scale on at least one axis, wherein the at least one scale presents a range of values associated with at least one business object attribute;
displaying, on the graphical user interface, at least one visual representation associated with at least one business object, wherein the at least one visual representation is positioned relative to the at least one scale;
in response to activation of a grouping mechanism, moving the at least one visual representation to a first area in the graphical user interface, wherein the at least one business object associated with the at least one visual representation includes at least one business object attribute value in common with other business objects visually represented in the first area; and
varying at least one visual property of the first area based on information associated with business objects visually represented in the first area, wherein the at least one visual property is at least one of a color, a pattern, a video, text, and an image in the first area.

2. A computer-implemented method comprising:
displaying, on a graphical user interface, at least one scale on at least one axis, wherein the at least one scale presents a range of values associated with at least one business object attribute;
displaying, on the graphical user interface, at least one visual representation associated with at least one business object, wherein the at least one visual representation is positioned relative to the at least one scale; and
in response to activation of a grouping mechanism, moving the at least one visual representation to a first area in the graphical user interface, wherein the at least one business object associated with the at least one visual representation includes at least one business object attribute value in common with other business objects visually represented in the first area.

3. The method of claim 2, wherein the activation of the grouping mechanism includes specifying at least one business object attribute value as a parameter of the grouping mechanism.

4. The method of claim 3, further comprising:
saving the specified at least one business object attribute value as a parameter available for subsequent grouping mechanism activations.

5. The method of claim 2, further comprising:
varying at least one visual property of the first area based on information associated with business objects visually represented in the first area.

6. The method of claim 5, wherein the at least one visual property is at least one of a color, a pattern, a video, text, and an image in the first area.

7. The method of claim 5, further comprising:
displaying a visual key to indicate at least a meaning of the at least one visual property.

8. An apparatus comprising:
a display to:
display at least one scale on at least one axis, wherein the at least one scale presents a range of values associated with at least one business object attribute, and
display at least one visual representation associated with at least one business object, wherein the at least one visual representation is positioned relative to the at least one scale; and
a processor to:
in response to activation of a grouping mechanism, move the at least one visual representation to a first area on the display, wherein the at least one business object associated with the at least one visual representation includes at least one business object attribute value in common with other business objects visually represented in the first area.

9. The apparatus of claim 8, further comprising:
an input device to:
specify at least one business object attribute value as a parameter of the grouping mechanism.

10. The apparatus of claim 9, wherein the processor is further configured to:
save the specified at least one business object attribute value as a parameter available for subsequent grouping mechanism activations.

11. The apparatus of claim 8, wherein the processor is further configured to:
vary at least one visual property of the first area based on information associated with business objects visually represented in the first area.

12. The apparatus of claim 11, wherein the at least one visual property is at least one of a color, a pattern, a video, text, and an image in the first area.

13. The apparatus of claim 11, wherein the display is further configured to:
display a visual key to indicate at least a meaning of the at least one visual property.

14. A non-transitory computer-readable medium embodied with computer-executable instructions for causing a computer to execute instructions, the computer instructions comprising:
displaying, on a graphical user interface, at least one scale on at least one axis, wherein the at least one scale presents a range of values associated with at least one business object attribute;
displaying, on the graphical user interface, at least one visual representation associated with at least one business object, wherein the at least one visual representation is positioned relative to the at least one scale; and
in response to activation of a grouping mechanism, moving the at least one visual representation to a first area in the graphical user interface, wherein the at least one business object associated with the at least one visual representation includes at least one business object attribute value in common with other business objects visually represented in the first area.

15. The computer-readable medium of claim 14, wherein the activation of the grouping mechanism includes specifying at least one business object attribute value as a parameter of the grouping mechanism.

16. The computer-readable medium of claim 15, further comprising:
saving the specified at least one business object attribute value as a parameter available for subsequent grouping mechanism activations.

17. The computer-readable medium of claim 14, further comprising:
varying at least one visual property of the first area based on information associated with business objects visually represented in the first area.

18. The computer-readable medium of claim 17, wherein the at least one visual property is at least one of a color, a pattern, a video, text, and an image in the first area.

19. The computer-readable medium of claim 17, further comprising:
displaying a visual key to indicate at least a meaning of the at least one visual property.
